(19) United States
(12) Patent Application Publication
(10) Pub. No.: US 2021/0180883 A1
(43) Pub. Date: Jun. 17, 2021

(54) HEAT EXCHANGER WITH ONE-PIECE THROUGH FITTINGS

(71) Applicant: Dana Canada Corporation, Oakville (CA)

(72) Inventors: Garreth D. G. GRAVES, Mississauga (CA); Mike ST. PIERRE, Hamilton (CA)

(21) Appl. No.: 16/717,504

(22) Filed: Dec. 17, 2019

(51) Int. Cl. F28F 9/007; B60H 1/00; F16B 7/14

(52) U.S. Cl. CPC F28F 9/0075; B60H 2001/00078; F16B 7/14; B60H 1/00042

(57) ABSTRACT

A heat exchanger has a fluid flow passage defined between first and second plates, and at least one through fitting having a one-piece construction. The through fitting has a first portion extending through a first hole of the first plate, a second portion extending a second hole of the second plate, and a radially outwardly extending third portion located between the first and second plates. The third portion of the through fitting has a first radially-extending surface in contact with the inner surface of the first plate and a second radially-extending surface in contact with the inner surface of the second plate. At least one communication passage is provided through the third portion of the through fitting between the fluid flow passage and the hollow interior of the through fitting. A plurality of the heat exchangers may be fluidly connected in parallel flow arrangement.

### TECHNICAL FIELD

The present disclosure relates to heat exchanger construction, and particularly to a heat exchanger having through-holes to permit passage of heat transfer fluid through the heat exchanger, and to thermal management systems incorporating such heat exchangers.

### BACKGROUND

Thermal management systems for vehicles may include two or more heat exchangers connected in parallel to common inlet and outlet manifolds. In some configurations, the individual heat exchangers of the system may include a pair of through-holes which function as inlet and outlet ports, and as parts of the inlet and outlet manifolds to distribute the heat transfer fluid to other heat exchangers in the system. An example of such a heat exchanger structure is illustrated in FIG. 1 of commonly assigned U.S. Pat. No. 10,006,722, which is incorporated herein by reference in its entirety.

The heat exchangers shown in FIG. 1 of U.S. Pat. No. 10,006,722 are provided with face seals surrounding the through openings on both sides of the heat exchanger, to enable the formation of sealed fluid connections with inlet and outlet manifolds provided in a frame structure. Some configurations use tubular fittings instead of face seals to form the fluid connections. These fittings may project at right angles from both sides of the heat exchanger, and are sealingly secured to the external surfaces of the heat exchanger. Where both the inlet and outlet ports of the heat exchanger comprise through-holes, a total of four fittings are required, two at the inlet port and two at the outlet port.

In addition, it may be difficult to achieve sufficient concentricity between two fittings provided on opposite sides of a through-hole, given that the alignment of the fittings is subject to positional tolerances. Also, in some heat exchanger constructions, the area of the fluid flow passage in the vicinity of each through-hole lacks internal support, and additional support elements may be required inside the fluid flow passage to prevent deformation of the plates in the vicinity of the through-hole. Such support elements are also disclosed in above-mentioned U.S. Pat. No. 10,006,722. In addition, where the fittings are brazed to the outer, unclad, surfaces of plates comprising the heat exchanger, rings of brazing filler metal may be required between the sealing surfaces of the fitting and the heat exchanger plate, thereby increasing the number of components required for assembly.

There is a need for an improved fitting construction of heat exchangers which include through-holes.

### SUMMARY

In accordance with an aspect of the present disclosure, there is provided a heat exchanger comprising a first plate having an inner surface, an outer surface and at least one first hole; and a second plate having an inner surface, an outer surface and at least one second hole. Each of the at least one first holes is in opposed, spaced relation to one of the at least one second holes. A fluid flow passage is defined between the inner surfaces of the first and second plates. The heat exchanger further comprises at least one through fitting, each of the through fittings having a one-piece structure and comprising a first portion, a second portion, and a third portion between the first and second portions.

According to an aspect, the first portion of each of the at least one through fittings extends through one of the at least one first holes of the first plate and has a first end opening.

According to an aspect, the second portion of each of the at least one through fitting extends through one of the at least one second holes of the second plate and has a second end opening, each of the at least one through fitting having a hollow interior extending from the first end opening to the second end opening.

According to an aspect, the third portion of each of the at least one through fitting is located between the first and second plates and has an outer periphery located radially outwardly of an outer surface of the first portion and an outer surface of the second portion.

According to an aspect, the third portion of each of the at least one through fitting has a first radially-extending surface in contact with the inner surface of the first plate and a second radially-extending surface in contact with the inner surface of the second plate.

According to an aspect, at least one communication passage is provided through the third portion of each of the at least one through fitting between the fluid flow passage and the hollow interior of the through fitting.

According to an aspect, the fluid flow passage extends between an inlet port and an outlet port.

According to an aspect, each of the inlet port and the outlet port is in the form of a through-opening comprising an opposed pair of the at least one first and second openings.

According to an aspect, the first, second and third portions of each through fitting are in concentric arrangement with one another along an axis of the through fitting, and are formed from a single cylindrical tube.

According to an aspect, each through fitting has a first end with a first end opening provided in the first portion, an opposite second end with a second end opening provided in the second portion, and a hollow interior extending between the first and second end openings.

According to an aspect, for each through fitting and each through opening, a first fluid-tight seal is provided between the outer surface of the first portion and the inner periphery of one of the first holes, and a second fluid-tight seal is between the outer surface of the second portion and the inner periphery of one of the second holes.

According to an aspect, for each through fitting, an outer periphery of the third portion is located radially outwardly of the outer surfaces of the first and second portions.

According to an aspect, the third portion of each through fitting has a first radially-extending surface and an opposite second radially-extending surface, wherein the first and second radially-extending surfaces are annular and flat.

According to an aspect, the first radially-extending surface of each through fitting is in contact with the inner surface of the first plate and the opposite second radially-extending surface is in contact with the inner surface of the second plate.

According to an aspect, the first and second plates are comprised of an aluminum alloy, and the inner surfaces of the plates are provided with a clad layer of a brazing alloy. In this case, the first and second radially-extending surfaces are sealingly joined to the inner surfaces of the first and second plates, with the clad layer forming a braze joint between the first and second radially-extending surfaces of the third portion and the inner surfaces of the first and second plates.

According to an aspect, a thickness of the third portion is slightly less than or substantially the same as a height of the fluid flow passage in an area surrounding each of the first and second openings.

According to an aspect, the third portion of each through fitting comprises a plurality of the communication passages.

According to an aspect, each of the communication passages extends radially through the third portion, and the communication passages are spaced apart along a circumference of the third portion.

According to an aspect, the third portion of each through fitting has a first radially-extending surface and an opposite second radially-extending surface, and wherein each of the communication passages comprises a notch formed in the third portion of the through fitting, such that the first and second radially-extending surfaces are interrupted by the communication passages.

In accordance with another aspect of the present disclosure, there is provided a thermal management system comprising a plurality of heat exchangers as described herein, wherein the heat exchangers are fluidly connected in parallel flow arrangement, and wherein the heat exchangers are spaced apart from one another to receive a component to be cooled and/or heated between outer surfaces of adjacent pairs of the heat exchangers.

In accordance with yet another aspect of the present disclosure, there is provided a method for manufacturing a through fitting for a heat exchanger as described herein. The method comprises: (a) providing a cylindrical tube having a sidewall and defining a tube axis; (b) forming a plurality of openings in the sidewall, the openings being aligned along the tube axis and spaced apart along a circumference of the sidewall; (c) applying an axial force along the tube axis to deform the tube and form a radially outwardly extending corrugation, wherein the corrugation includes the plurality of openings; and (d) flattening the corrugation. The corrugation, after it is flattened, comprises the third portion of the through fitting.

According to an aspect of the method described herein, the plurality of openings included in the flattened corrugation comprises the at least one communication passage of the through fitting.

According to an aspect of the method described herein, an initial height of the openings in the sidewall of the cylindrical tube, as measured along the tube axis, is about twice a radial width of the third portion of the through fitting, as measured perpendicular to the tube axis.

### BRIEF DESCRIPTION OF THE DRAWINGS

Exemplary embodiments of the present disclosure will now be described, by way of example, with reference to the accompanying drawings, in which:

FIG. 1 is a perspective view of a plurality of heat exchangers in parallel flow arrangement;

FIG. 2 is a cross section along line 2-2′ of FIG. 1;

FIG. 3 is an enlarged close-up of a portion of FIG. 1;

FIG. 4 is a perspective view of a one-piece through fitting;

FIG. 5 is a vertical cross-section through the one-piece through fitting of FIG. 4;

FIG. 6 is a top plan view of the one-piece through fitting of FIG. 4;

FIG. 7 is an explanatory plan view of a known fitting arrangement;

FIG. 8 is an explanatory view of a through fitting according to a second embodiment; and

FIGS. 9A, 9B and 9C illustrate steps in a method for manufacturing a through fitting.

### DETAILED DESCRIPTION

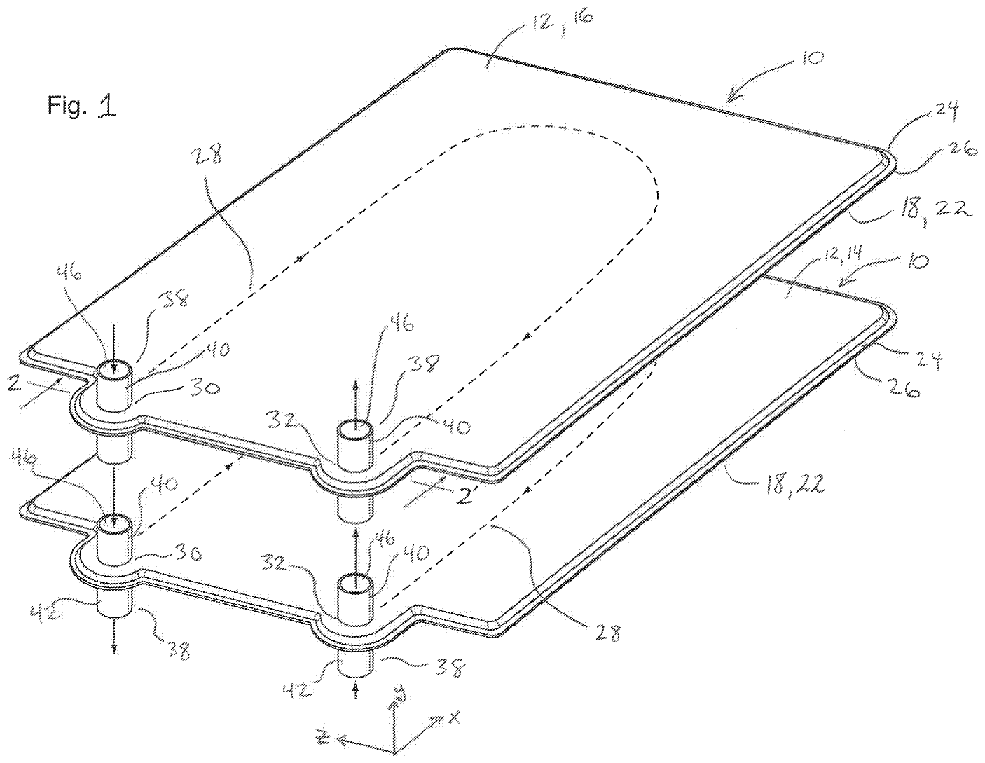

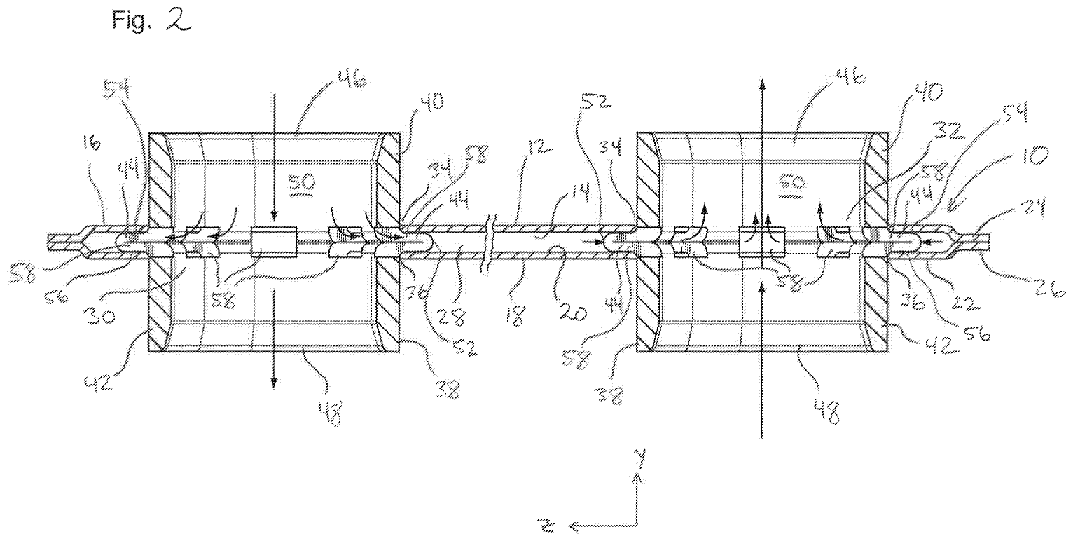

FIG. 1 illustrates a plurality of heat exchangers 10 which are arranged for parallel flow arrangement, and FIGS. 2 and 3 show close-up views of a portion of one of the heat exchangers 10. As used herein, the term “parallel flow arrangement” means that the heat exchangers 10 are joined or adapted to be joined to common inlet and outlet manifolds which distribute the heat transfer fluid to the plurality of heat exchangers 10.

Each heat exchanger 10 comprises a first plate 12 having inner and outer surfaces 14, 16, and a second plate 18 having inner and outer surfaces 20, 22.

The first and second plates 12, 18 may include peripheral flanges 24, 26 along which the first and second plates 12, 18 are sealingly joined together, for example by brazing. The first and second plates 12, 18 may be comprised of an aluminum alloy, and the inner surfaces 14, 20 of the plates 12, 18 may be provided with a clad layer of a brazing alloy (not shown) which, when heated to a sufficiently high temperature, melts to form a braze filler metal which forms a braze joint between the peripheral flanges 24, 26.

Portions of the first and second plates 12, 18 located inwardly of the peripheral flanges 24, 26 are spaced apart from one another, with a fluid flow passage 28 being defined between the inner surfaces 14, 20 of the first and second plates 12, 18.

The fluid flow passage 28 extends between an inlet port 30 and an outlet port 32. In the present embodiment, the inlet and outlet ports 30, 32 are located along the same end of the heat exchanger 10, and the fluid flow passage 28 is schematically shown as being U-shaped. It will be appreciated, however, that the relative locations of the inlet and outlet ports 30, 32 and the configuration of the fluid flow passage 28 are exemplary only, and are not material to the present disclosure. In heat exchangers according to alternate embodiments, the inlet and outlet ports 30, 32 may be located at opposite ends of the heat exchanger, or one or both ports 30, 32 may be located between the ends of the heat exchanger. The fluid flow passage 28 may include one or more elements to guide the flow of heat transfer fluid between the inlet and outlet ports 30, 32, such as embossments in the first and/or second plates 12, 18, a separate embossed middle plate between the first and second plates 12, 18, and/or corrugated fins or turbulizers between the first and second plates 12, 18.

Each of the inlet port 30 and the outlet port 32 are in the form of through-openings, that is, the inlet and outlet ports 30, 32 both extend through the heat exchanger 10 and are in fluid communication with the fluid flow passage 28. Each of these through-openings 30 or 32 comprises a first hole 34 formed in the first plate 12 and a second hole 36 formed in the second plate 18, the first hole 34 and the second hole 36 being in opposed, spaced relation to each other. In the present embodiment, the first and second holes 34, 36 are circular holes of substantially the same diameter and are substantially concentric, within applicable tolerances.

Providing inlet and outlet ports 30, 32 in the form of through-openings facilitates the connection of a plurality of heat exchangers 10 in parallel flow arrangement, as shown in FIG. 1, with the inlet ports 30 of adjacent heat exchangers 10 being in alignment with one another and the outlet ports 32 of adjacent heat exchangers 10 being in alignment with one another. For example, as shown in FIG. 1, the direction of fluid flow through the aligned inlet and outlet ports 30, 32 is parallel to the y-axis, while the plates 12, 18 and the fluid flow passage may be aligned along the x-axis, the x and y axes being at right angles to each other. The heat exchangers 10 of FIG. 1 are parallel to each other (along x-axis) and are spaced apart from one another to permit a component to be cooled and/or heated to be inserted between the outer surfaces of adjacent heat exchangers 10, and in thermal contact therewith. For example, the component to be cooled and/or heated may comprise a battery cell of a rechargeable vehicle battery (not shown). A battery thermal management system for cooling and optionally heating rechargeable vehicle batteries may include a large number of such heat exchangers 10 fluidly connected in parallel flow arrangement, with at least one battery cell being received between adjacent heat exchangers 10, and with the flat side of at least one battery cell being in thermal contact with each outer surface of each heat exchanger 10, for example as described in commonly assigned U.S. patent application Ser. No. 16/688,390 filed on Nov. 19, 2019 and in above-mentioned U.S. Pat. No. 10,006,722. Rigid or flexible tubular fluid connections (not shown) may be formed between the inlet ports 30 of adjacent heat exchangers 10 and between the outlet ports 32 of adjacent heat exchangers 10. The thermal management system may include separate inlet and outlet manifolds (not shown) to which the through fittings are connected by the fluid connections. Alternatively, the fluid connections may directly connect the fittings of adjacent heat exchangers together, in which case the inlet and outlet manifolds may be comprised entirely of the through fittings and the tubular fluid connections which connect them together.

Each of the inlet ports 30 and outlet ports 32 of heat exchangers 10 is provided with a one-piece through fitting 38 having a first portion 40, a second portion 42 and a third portion 44 located between the first and second portions 40, 42. In the present embodiment, the first, second and third portions 40, 42, 44 of the one-piece through fitting 38 are in precise concentric arrangement with one another along the y-axis, and may be formed from a single cylindrical tube.

The through fitting 38 has a first end with a first end opening 46 provided in the first portion 40, and an opposite second end with a second end opening 48 provided in the second portion 42. A hollow interior 50 of the through fitting 38 extends between the first and second end openings 46, 48.

The first portion 40 of each through fitting 38 extends through one of the first holes 34 of the first plate 12, and is closely received therein. Similarly, the second portion 42 of each through fitting 38 extends through one of the second holes 36 of the second plate 18, and is closely received therein. Fluid-tight seals are formed between the outer surface of the first portion 40 and the inner periphery of the first hole 34, and between the outer surface of the second portion 42 and the inner periphery of the second hole 36. In the present embodiment, the holes 34, 36 are circular and the first and second portions 40, 42 of through fitting are cylindrical tubular elements having a circular cross-section, although other shapes may be used so long as a fluid-tight seal is provided between the through fitting 38 and the holes 34, 35 of plates 12, 18. Although not essential, the first and second holes 34, 36 in the present embodiment are of the same diameter, and the first and second portions 40, 42 of through fitting have the same diameter.

The third portion 44 of through-fitting 38 extends radially outwardly (along x-axis) beyond the outer surfaces of the first and second portions 40, 42, with an outer periphery 52 located radially outwardly of the outer surfaces of the first and second portions 40, 42. In the present embodiment the third portion 44 has an annular shape with the outer periphery 52 being circular, and concentric with the first and second portions 40, 42 of through fitting 38.

The third portion 44 of the through fitting 38 has a first radially-extending surface 54 (top surface in FIGS. 2 and 3), and an opposite second radially-extending surface 56 (bottom surface in FIGS. 2 and 3), the surfaces 54 and 56 being annular and flat. The first radially-extending surface 54 is in contact with the inner surface 14 of first plate 12 and the second radially-extending surface 56 is in contact with the inner surface 20 of the second plate 18. The first and second radially-extending surfaces 54 may be sealingly joined to the inner surfaces 14, 20 of the first and second plates 12, 18, with the clad layer on the inner surfaces 14, 20 forming a braze joint between the surfaces 54, 56 of third portion 44 and the respective inner surfaces 14, 20 of plates 12, 18.

Therefore, the thickness of the third portion 44, as measured along the y-axis between the first and second radially-extending surfaces 54, 56 is slightly less than or substantially the same as the height of the fluid flow passage 28 in the area surrounding each of the inlet and outlet ports 30, 32. The third portion 44 therefore provides structural support for the heat exchanger 10 in the area of the inlet and outlet ports, which is subject to deformation due to the relative thinness and flatness of the sheet metal material comprising the first and second plates 12, 18. The presence of the third portion 44 of through fitting 38 therefore avoids the need to provide support structures between the plates 12, 18 in the vicinity of inlet and outlet ports 30, 32. Such alternate support structures may take the form of separate components which are inserted between the plates 12, 18 during assembly, or embossments in the plates. The present embodiment avoids the need for such alternate support structures, thereby reducing the number of components and/or simplifying the structure of the plates 12, 18.

Fluid communication between the hollow interior 50 of through fitting 38 and the fluid flow passage 28 is provided through the third portion 44 of through fitting 38. In this regard, at least one communication passage 58 is provided between the outer periphery 52 of third portion 44 and the hollow interior 50 of the through fitting 38. As shown in the present embodiment, the through fitting 38 comprises a plurality of communication passages 58. The communication passages 58 may extend radially through the third portion 44, and may be provided in spaced relation throughout the entire circumference of the third portion 38. However, in other embodiments, the communication passages 58 may be only located along a portion of the circumference of third portion 58 so as to guide the fluid flow in a specific direction.

The communication passages 58 may be enclosed between the first and second radially-extending surfaces 54, 56 of the third portion 44. However, in the present embodiment, the communication passages 58 comprise notches formed in the third portion 44 of through fitting 38, such that the first and second radially-extending surfaces 54, 56 are interrupted by the communication passages 58.

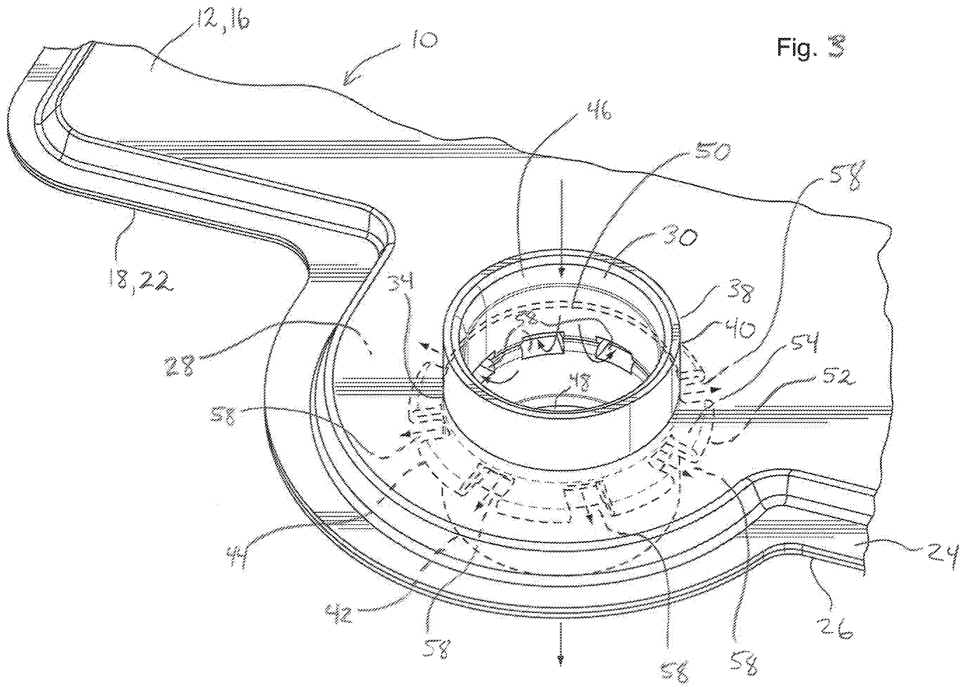

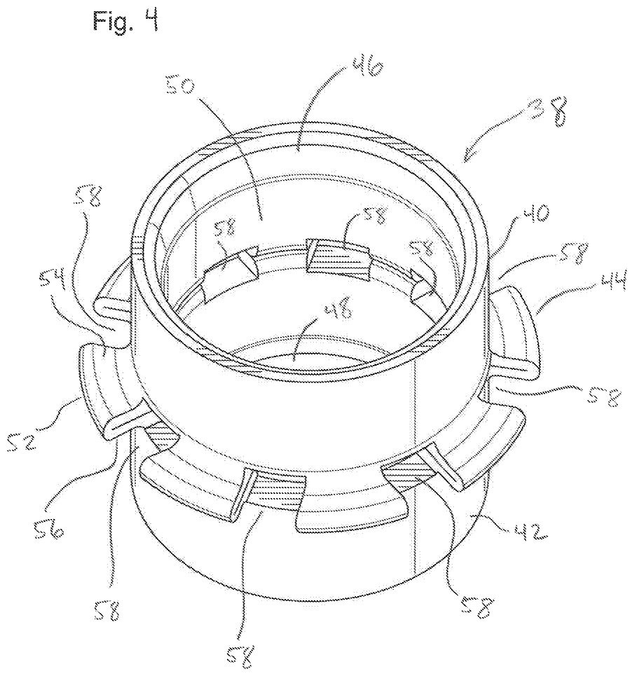

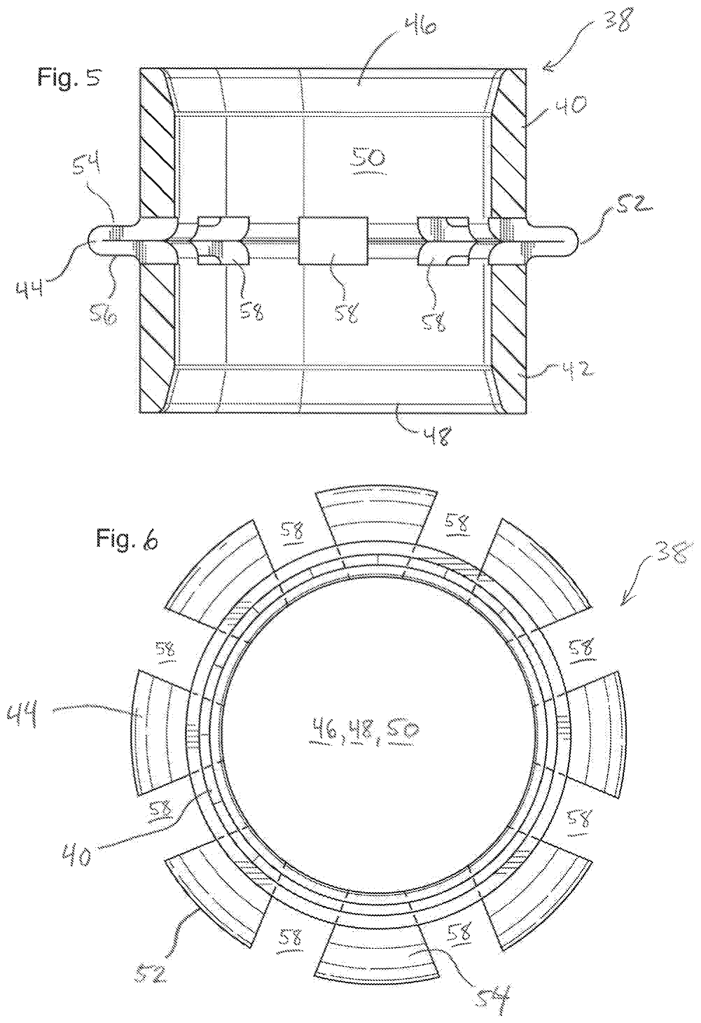

The through-fitting may be manufactured by various methods. FIGS. 2-6 show that the third portion 44 comprises two layers, and is in the form of a flattened corrugation or flange. Such a corrugation may conveniently formed by deforming an unsupported portion of a cylindrical tube by applying a force along the axis of the tube, to form a corrugation which is flattened and simultaneously reduced in thickness, if required, to form the third portion 44. The communication passages 58 may be formed, for example by machining, after formation of the flattened corrugation. Alternatively, as further described below, the communication passages 58 may be formed by providing rectangular openings in the wall of the cylindrical tube, before deformation. The height of the rectangular openings in the cylindrical tube will be approximately twice the width of the third portion (i.e. radial distance between the outer periphery 52 and the outer surfaces of first and second portions 40, 42.

FIG. 7 shows a known through fitting arrangement for an inlet or outlet port 102 of a heat exchanger 100 comprising first and second plates 104, 106 provided with holes 108, 110. Each hole 108, 110 is provided with a fitting 112 having a hollow interior, and provided with a radial flange 116 which forms a sealed connection to the outer surface of the first or second plate 104, 106. The fittings 112 may also include end portions 118 which are received inside holes 108, 110 to locate the fittings 112 inside the holes 108, 110. As will be appreciated, positional tolerances may cause the fittings 112 of holes 108, 110 to be slightly out of concentric alignment with each other.

Furthermore, the outer surfaces of plates 104, 106 of heat exchanger 100 are not typically provided with a clad layer of brazing alloy. Therefore, annular shims (not shown) comprising brazing alloy may be required between flanges 116 and the outer surfaces of plates 104, 106. As a result, the through fitting arrangement of FIG. 7 requires two separate fittings 112 and may additionally require two annular brazing shims.

Also, because the fittings 112 are secured to the outer surfaces of plates 104, 106, they do not provide internal support for the relatively thin plates 104, 106 of heat exchanger 100 in the vicinity of holes 108, 110. Without the provision of additional support elements between the plates 104, 106, the plates 104, 106 may be deformed, for example during assembly of a thermal management system comprising a plurality of heat exchangers 100 in parallel flow arrangement. Thus, the heat exchanger 100 of FIG. 7 is susceptible to undesirable deformation, and/or may require additional support elements to prevent deformation.

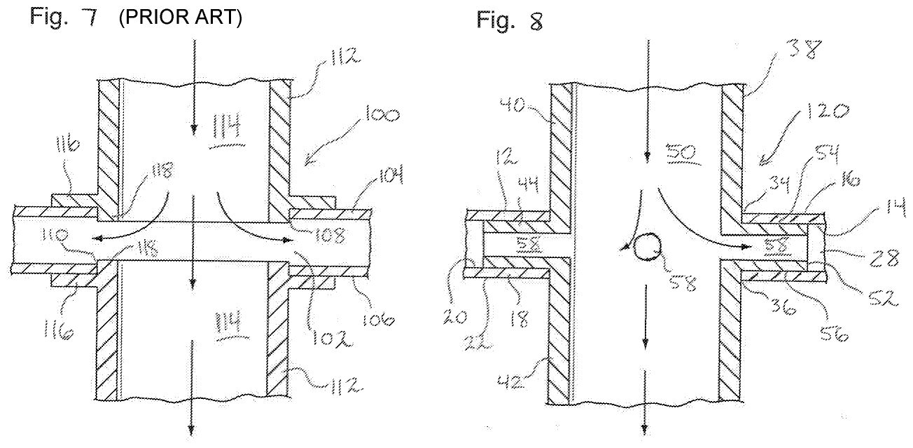

FIG. 8 illustrates a portion of a heat exchanger 120 according to a second embodiment. Heat exchanger 120 shares a number of like elements with heat exchanger 10 described above, and these like elements are identified with like reference numerals.

Heat exchanger 120 is identical to heat exchanger 10 except for the structure of through fitting 38, in which the third portion 44 is in the form of a single-layer radially projecting flange, which may be formed by molding and/or machining. Also, the communication passages 58 are enclosed between the first and second radially-extending surfaces 54, 56, and may be in the form of radially-extending cylindrical bores extending from the outer periphery 52 to the hollow interior 50.

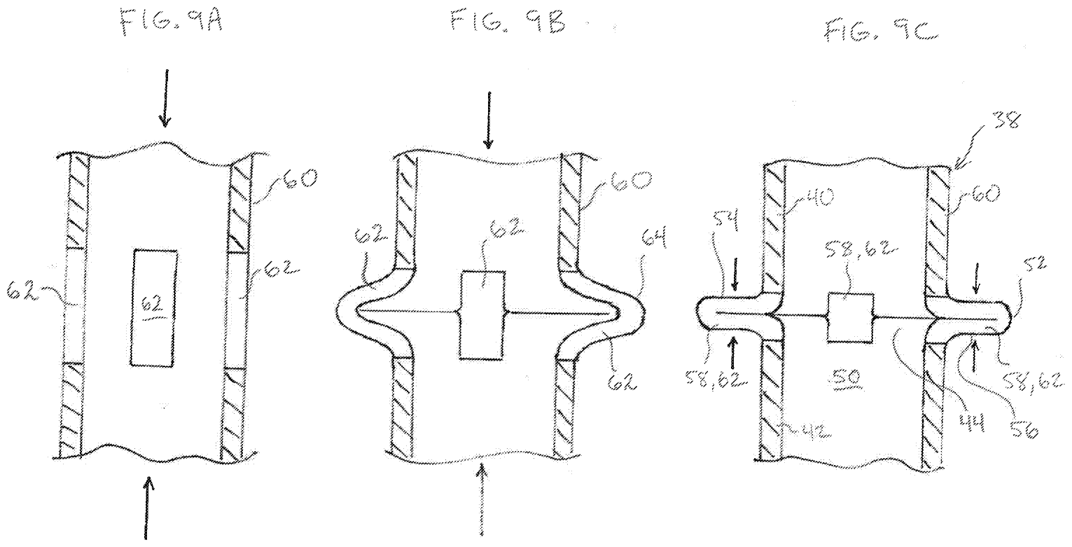

FIGS. 9A, 9B and 9C schematically show the steps in a method for manufacturing a through fitting 38 as described herein. FIG. 9A shows a cylindrical tube 60 having a plurality of rectangular openings 62 formed in its sidewall, the openings 62 being aligned along the tube axis and being spaced apart along the circumference of the tube wall. Axial forces are applied to the tube 60 as indicated by arrows in FIGS. 9A and 9B, and these axial forces cause the tube 60 to be deformed to form a radially outwardly extending corrugation 64. Continued deformation of the tube 60 as shown in FIG. 9B will flatten the corrugation 64 and, as shown in FIG. 9C, the corrugation 64 may be further flattened so as to form the third portion 44 of the through fitting 38, to flatten the first and second radially-extending surfaces 54, 56 and to optionally reduce the thickness of the corrugation 64, as indicated by the arrows in FIG. 9C, so that it will fit between the first and second plates 12, 18 of a heat exchanger 10. As can be seen from FIGS. 9A to 9C, the initial height of the rectangular openings 62 along the tube axis, as shown in FIG. 9A, is approximately twice the width of the third portion 44, as measured perpendicular to the tube axis from the outer periphery 52 to the outer surfaces of first and second portions 40, 42.

While various embodiments have been described in connection with the present disclosure, it will be understood that certain adaptations and modifications of the described exemplary embodiments can be made as construed within the scope of the present disclosure. Therefore, the above discussed embodiments are considered to be illustrative and not restrictive.

What is claimed is:

1. A heat exchanger comprising:
(a) a first plate having an inner surface, an outer surface and at least one first hole;
(b) a second plate having an inner surface, an outer surface and at least one second hole, wherein each of the at least one first holes is in opposed, spaced relation to one of said at least one second holes;
(c) a fluid flow passage defined between the inner surfaces of the first and second plates;
(d) at least one through fitting, each said through fitting having a one-piece structure and comprising a first portion, a second portion, and a third portion between the first and second portions;
wherein the first portion of each of the at least one through fittings extends through one of the at least one first holes of the first plate and has a first end opening;
wherein the second portion of each of the at least one through fitting extends through one of the at least one second holes of the second plate and has a second end opening, each of the at least one through fitting having a hollow interior extending from the first end opening to the second end opening;
wherein the third portion of each of the at least one through fitting is located between the first and second plates and has an outer periphery located radially outwardly of an outer surface of the first portion and an outer surface of the second portion;
wherein the third portion of each of the at least one through fitting has a first radially-extending surface in contact with the inner surface of the first plate and a second radially-extending surface in contact with the inner surface of the second plate; and
wherein at least one communication passage is provided through the third portion of each of the at least one through fitting between the fluid flow passage and the hollow interior of the through fitting.

2. The heat exchanger according to claim 1, wherein the fluid flow passage extends between an inlet port and an outlet port.

3. The heat exchanger according to claim 2, wherein each of the inlet port and the outlet port is in the form of a through-opening comprising an opposed pair of said at least one first and second openings.

4. The heat exchanger according to claim 1, wherein the first, second and third portions of each said through fitting are in concentric arrangement with one another along an axis of the through fitting, and are formed from a single cylindrical tube.

5. The heat exchanger according to claim 1, wherein each said through fitting has a first end with a first end opening provided in the first portion, an opposite second end with a second end opening provided in the second portion, and a hollow interior extending between the first and second end openings.

6. The heat exchanger according to claim 1, wherein, for each said through fitting and each said through opening, a first fluid-tight seal is provided between the outer surface of the first portion and the inner periphery of one said first hole, and a second fluid-tight seal is provided between the outer surface of the second portion and the inner periphery of one said second hole.

7. The heat exchanger according to claim 1, wherein, for each said through fitting, an outer periphery of the third portion is located radially outwardly of the outer surfaces of the first and second portions.

8. The heat exchanger according to claim 1, wherein the third portion of each said through fitting has a first radially-extending surface and an opposite second radially-extending surface, wherein the first and second radially-extending surfaces are annular and flat.

9. The heat exchanger according to claim 8, wherein the first radially-extending surface of each said through fitting is in contact with the inner surface of the first plate and the opposite second radially-extending surface is in contact with the inner surface of the second plate.

10. The heat exchanger according to claim 9, wherein the first and second plates are comprised of an aluminum alloy, wherein the inner surfaces of the plates are provided with a clad layer of a brazing alloy, wherein the first and second radially-extending surfaces are sealingly joined to the inner surfaces of the first and second plates, with the clad layer forming a braze joint between the first and second radially-extending surfaces of the third portion and the inner surfaces of the first and second plates.

11. The heat exchanger according to claim 1, wherein a thickness of the third portion is slightly less than or substantially the same as a height of the fluid flow passage in an area surrounding each of the first and second openings.

12. The heat exchanger according to claim 1, wherein the first and second plates are comprised of an aluminum alloy, and wherein the inner surfaces of the plates are provided with a clad layer of a brazing alloy.

13. The heat exchanger according to claim 1, wherein the third portion of each said through fitting comprises a plurality of said communication passages.

14. The heat exchanger according to claim 13, wherein each of the communication passages extends radially through the third portion, and the communication passages are spaced apart along a circumference of the third portion.

15. The heat exchanger according to claim 13, wherein the third portion of each said through fitting has a first radially-extending surface and an opposite second radially-extending surface, and wherein each of the communication passages comprises a notch formed in the third portion of the through fitting, such that the first and second radially-extending surfaces are interrupted by the communication passages.

16. A thermal management system comprising a plurality of heat exchangers according to claim 1, wherein the heat exchangers are fluidly connected in parallel flow arrangement, and wherein the heat exchangers are spaced apart from one another to receive a component to be cooled and/or heated between outer surfaces of adjacent pairs of said heat exchangers.

17. A method for manufacturing a through fitting for the heat exchanger according to claim 1, the method comprising:
(a) providing a cylindrical tube having a sidewall and defining a tube axis;
(b) forming a plurality of openings in the sidewall, the openings being aligned along the tube axis and spaced apart along a circumference of the sidewall;
(c) applying an axial force along the tube axis to deform the tube and form a radially outwardly extending corrugation, wherein the corrugation includes the plurality of openings; and
(d) flattening the corrugation;
wherein the corrugation, after it is flattened, comprises the third portion of the through fitting; and
wherein the plurality of openings included in the flattened corrugation comprises the at least one communication passage of the through fitting.

18. The method according to claim 17, wherein an initial height of the openings in the sidewall of the cylindrical tube, as measured along the tube axis, is about twice a radial width of the third portion of the through fitting, as measured perpendicular to the tube axis.
